(19) United States
(12) Patent Application Publication
(10) Pub. No.: US 2019/0050199 A1
(43) Pub. Date: Feb. 14, 2019

(54) LOCALIZED GRID SORT

(71) Applicants: Richard Allen, Chalfont St Peter (GB); Xiran Huang, High Wycombe (GB)

(72) Inventors: Richard Allen, Chalfont St Peter (GB); Xiran Huang, High Wycombe (GB)

(21) Appl. No.: 15/941,567

(22) Filed: Mar. 30, 2018

(51) Int. Cl. G06F 7/16; G06F 3/06

(52) U.S. Cl. CPC G06F 7/16; G06F 3/0611; G06F 3/0673; G06F 3/0652; G06F 3/0656

(57) ABSTRACT

System and techniques for a localized grid sort are described herein. Elements that have a first-dimension value and a second-dimension value, and correspond to a cell value, are obtained for sorting. Each element is placed into one of a set of first-in-first-out (FIFO) buffers based on a difference between the first-dimension value for the element and a first coordinate of the cell value in the first-dimension. The set of FIFO buffers are then merged by outputting a lowest value element each comparison. This creates a stream of elements (e.g., elements stream) sorted in the first dimension. The elements from the element stream are placed into a set of window buffers. In response to the next element in the element stream not being in the set of window buffers, a lowest buffer from the set of buffers is flushed to produce an output stream of sorted elements.

### TECHNICAL FIELD

Embodiments described herein generally relate to a real-time sensor fusion systems and more specifically to a localized grid sort.

### BACKGROUND

Sensor fusion is a complex and expansive field with many useful applications. An emerging application includes using images captured from vision sensors—such as cameras, RADAR, LiDAR, etc.—as primary sensors to control systems, such as may be found in advanced driver assistance (ADAS) or autonomous vehicle systems. In these applications, the images are processed to detect a variety of environmental characteristics, such as identifying obstacles, vehicle paths (e.g., roads or paths), identifying signals (e.g., road signs, runway markers, etc.), or observation targets (e.g., pedestrians, wildlife, etc.).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment including a system to implement a localized grid sort, according to an embodiment.

FIG. 2 illustrates an example of obtaining elements in a grid scan and populating a set of displacement first-in-first-out (FIFO) buffers, according to an embodiment.

FIG. 3 illustrates examples of block headers for memory blocks containing displacement FIFO data, according to an embodiment.

FIG. 4 illustrates an example of a component message flow for roughly sorting elements in displacement FIFO buffers stored in memory, according to an embodiment.

FIG. 5 illustrates an example of a component message flow for completing a sort from a roughly sorted element stream, according to an embodiment.

FIG. 6 illustrates a flow diagram of an example of a method for a localized grid sort, according to an embodiment.

FIG. 7 is a block diagram illustrating an example of a machine upon which one or more embodiments may be implemented.

### DETAILED DESCRIPTION

A variety of techniques may be used to combine multiple sensor data for real-time control systems, such as those found in autonomous vehicles. Generally, data from multiple sensors are combined in a 2 or 3 dimensional map of the environment in which objects are identified and classified in the data, with different objects leading to different control responses, such as stopping or maneuvering to avoid striking a pedestrian. A common technique for object localization includes segmenting a map into a grid that is scaled to correspond to physical distances. For example, a camera image may be segmented into a two-dimensional grid where each cell of the grid corresponds to a twenty centimeter by twenty centimeter portion of the environment as observed by the sensor. Techniques to determine object flow across this grid may include identifying which cells in a grid are occupied at any moment in time. Then, on an updated sensor reading—which may occur every ten milliseconds or so—the elements (e.g., particles) in a cell are found (e.g., via estimation of object velocity, etc.) in the updated grid and placed into a new cell when they move.

Although the updated cell-to-element value has already been calculated by the sensor fusion system, the elements are not in the updated grid-cell order because the updates are measured from the previous grid cell position. That is, the update scan starts with a first cell in a first row of the grid prior to the update to get a list of elements to look for in the updated image. The elements are located and the new cell for each element is computed. The update scan then proceeds to the second cell of the first row and repeats the process until all cells have been visited. Before this process is repeated on the updated cell values (e.g., after another image update), the elements are sorted into a grid-cell order again. This process may be referred to as dynamic grid fusion with a particle filter, which may provide a robust representation of the environment for fully autonomous driving, or other real-time uses of sensor fusion as inputs to controls systems.

Performing the cell-grid sort (e.g., re-aligning elements to each grid cell) is an expensive (e.g., computationally in time or circuit complexity) operation. For example, given the generally large number of elements (e.g., eight million or so), the sort process consumes large computation resources on a central processing unit (CPU), graphics processing unit (GPU), or field programmable gate array (FPGA) platform, making real-time performance difficult to achieve. Different types of sort techniques, such as Quick Sort or Bitonic sort on CPU or GPU, or Merge Sort on FPGA, have been tried but often suffer a variety of problems, such as low performance—these conventional sorts take a long time to process a large number of elements. Another problem is high latency—these sorts often cannot output any element until the last element is received in a pipeline approach, or output any element until all elements have been sorted in a memory-based (e.g., in-memory) approach. Another problem is inability to work with limited resources—for example, a Merge sort on a FPGA, a frequent choice for designers, even on a capable FPGA device may only support 512 thousand elements at a time. Another problem is memory bandwidth—these sorts generally consume large amounts of memory bandwidth that grow larger (e.g., scales quickly) as the number of elements grow.

To address these issues, and enable true-real-time sensor fusion for control systems input, a localized grid sort is described herein. The localized grid sort takes advantage of a localization property of elements. That is, if elements represent real-world objects, then the distance these objects may move between image updates is constrained by real-world physics. Thus, an element that started in a first cell, cannot physically move beyond a threshold number of cells away from the first cell when it is updated. Thus, the sort may operate on a much smaller moving window of cells than the entire grid.

The localized grid sort may be efficiently implemented in a resource-constrained FPGA, or the like, via a two-phase sort in which elements are sorted in a first grid dimension as the grid is scanned. These result of this first phase may be stored in memory. As it is read out of memory, the second phase of the sort progresses by first roughly sorting the elements in the second dimension and then output a finely sorted stream of elements in the updated grid cell order. Each phase of the sort takes advantage of a maximum element move (e.g., a maximum velocity or Vmax) parameter.

The localized grid sort may be optimized to minimize the number of element comparisons, while maintaining a highly flexible, efficient, low latency, and scalable solution. Thus, the localized grid sort enables large number of elements to be processed in a real-time processing window. This will, in turn, facilitate more capable and practical FPGA based sensor fusion systems for control systems.

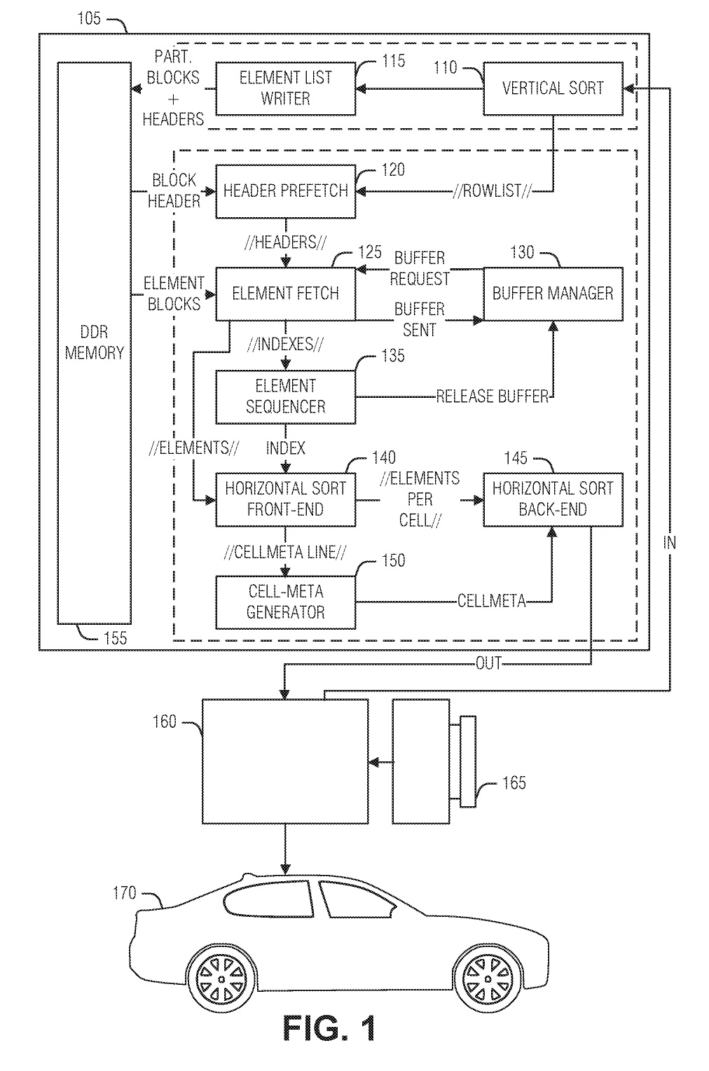

FIG. 1 is a block diagram of an example of an environment including a system to implement a localized grid sort, according to an embodiment. The environment includes a sensor fusion system 160 that receives input (e.g., images) from a sensor 165—such as a camera, RADAR, LiDAR, ultrasound sensors, etc.—and includes, or is communicatively coupled to in operation, circuitry 105 (e.g., an FPGA, application specific integrated circuit (ASIC), etc.) to perform the localized grid sort. The sensor fusion system 160 is illustrated as part of a vehicle 170, but it may also be used in other automated control systems, such as security systems, industrial control systems, etc.

The circuity 105 is illustrated with a number of discrete hardware components to efficiently implement the localized grid sort. However, not all illustrated components may be used in every implementation. The invariable components may include the vertical sort circuitry 110, the horizontal sort front-end circuitry 140, and the horizontal sort back-end circuitry 145. The remaining components provide efficient interfaces to FPGA memory, such as the double data rate (DDR) memory 155 typically employed in a variety of devices.

In implementing the grid-based particle filter, the circuitry 105, after an element update stage of the sensor fusion system 160—e.g., after the circuitry 105 receives the elements via an input interface, the circuitry 105 sorts the element's cells to enable, in a next update iteration, weighting and resampling of elements on a cell-by-cell basis. As noted above, the illustrated two-phase approach described here takes advantage of physical limits on element movement. The message flow and component operations may begin by receiving a cell-ordered stream of elements as input into the vertical sort circuitry 110. The elements will each include a value for the dimensions of the grid, such as a vertical and a horizontal value corresponding to a cell coordinate into which the elements are located after the updated.

The vertical sort circuitry 110 maintains a set of FIFO buffers, also referred to as displacement FIFOs, based on the maximum element move parameter, which is a configurable parameter. The maximum element move parameter defines the maximum number of cells, in any direction, that an element may move between updates. For example, if each grid cell corresponds to twenty centimeters, and each update occurs every ten milliseconds, a maximum element move parameter of seven corresponds to a maximum velocity of an element of 504 kilometers per hour. The number of FIFO buffers maintained by the vertical sort circuitry 110 is two times the maximum element move parameter—one set for positive vertical movement and another set for negative vertical movement—plus one for no vertical movement of the element. The FIFOs are displacement-based because the particular FIFO into which an element is placed is based on a difference between the vertical coordinate of the cell being scanned (e.g., the pre-update cell of the element) and the vertical value of the element after the updated. Thus, an element with no vertical movement is placed in the center FIFO while an element with maximum positive or negative vertical movement is placed in either the first or the last FIFO in the set.

The FIFOs may be maintained in a register and written to memory 155 in blocks by the element list writer 115 (e.g., a memory writer). In an example, the blocks are four kilobyte blocks. Block writing the elements provides more efficient memory access because memory read latency may be high compared to the circuitry 105 operating speed, and many memories have a minimum access size (e.g., 512-bits), entailing a read and then a write to write less than the minimum access size. By collating and writing in this manner, more data is transferred with fewer memory accesses resulting in lower latencies.

To support block-based memory accesses, the element list writer 115 may also be configured to create and write block headers. A block header may include some metrics about the block to which it refers, such as a count of elements in the block, whether the block signals an end of a row or grid, and an address in memory 155 for its corresponding block. In an example, the block headers are written contiguously in the memory 155 and separate from the blocks themselves in the memory 155.

The contiguous writing of block headers enables the header pre-fetch circuitry 120 to efficiently read in several block headers and provide organization data to the element fetch circuitry 125. The element fetch circuitry 125 retrieves the element blocks from the memory 155 and may use a buffer manager 130 to buffer the elements before sending element lists to the element sequencer 135. In an example, the element sequencer 135 keeps the process moving forward when, for example, an end-of row, or other data starvation condition is signaled (e.g., via a block header flag), by signaling the buffer manager 130 to release another buffer into the pipeline.

The element sequencer 135 organizes the fetched elements into a set of inputs to the horizontal sort front-end circuitry 140 according to the displacement FIFOs originally used by the vertical sort circuitry 110. With these inputs, and maintaining the FIFO nature of the displacement FIFOs, the horizontal sort front-end circuitry 140 merges the FIFOs into a roughly sorted element stream. The elements are roughly sorted because, while they are sorted vertically, they may still be within plus or minus the maximum element move parameter in the horizontal direction. The horizontal sort front-end circuitry 140 performs the rough sort by including a layered set of comparators that compare the elements from the inputs. At each comparison, the element with the lowest vertical and horizontal value progresses to the next layer until it is the only element. At this point, that element is written to the roughly sorted element stream. Then, a next element progresses through the comparators until all elements have been processed. The FIFO nature, and order in which the elements were placed into the FIFOs, ensures that this efficient comparator design maintains the already sorted vertical component while keeping elements within the maximum element move rate from each other, without using more than the original maximum element move rate times two plus one FIFOs.

To complete the sort, the roughly sorted element stream is provided as input into the horizontal sort back-end circuitry 145 (e.g., moving window circuitry), which completes the horizontal aspect of the sort. To achieve the final horizontal sort, the horizontal sort back-end circuitry 145 may include a number of buffers equal to the maximum element move rate. Each buffer is initially assigned a displacement value. As the roughly sorted elements are received, if any element cannot be placed into one of the buffers, then the lowest buffer may be flushed. This happens because the roughly sorted elements are not more than the maximum element move rate from each other, and thus if the element cannot be placed in an available buffer, it must represent the exhaustion of elements that correspond to the lowest buffer. As the lowest buffer is flushed into the fully sorted element stream, it is replaced as the highest value buffer. This process repeats until there are no more elements, constantly putting out a fully sorted element stream as early as the arrival of elements in a window of cells corresponding to the maximum element move rate.

The cell-metadata generator 150 may optionally coordinate grid metrics, such as row ends, grid ends, etc. with the horizontal sort back-end circuitry 145. Thus, the fully sorted elements are streamed out in a grid-cell order to be used in the sensor fusion system 160. Additional examples and details of these components or operations are described below.

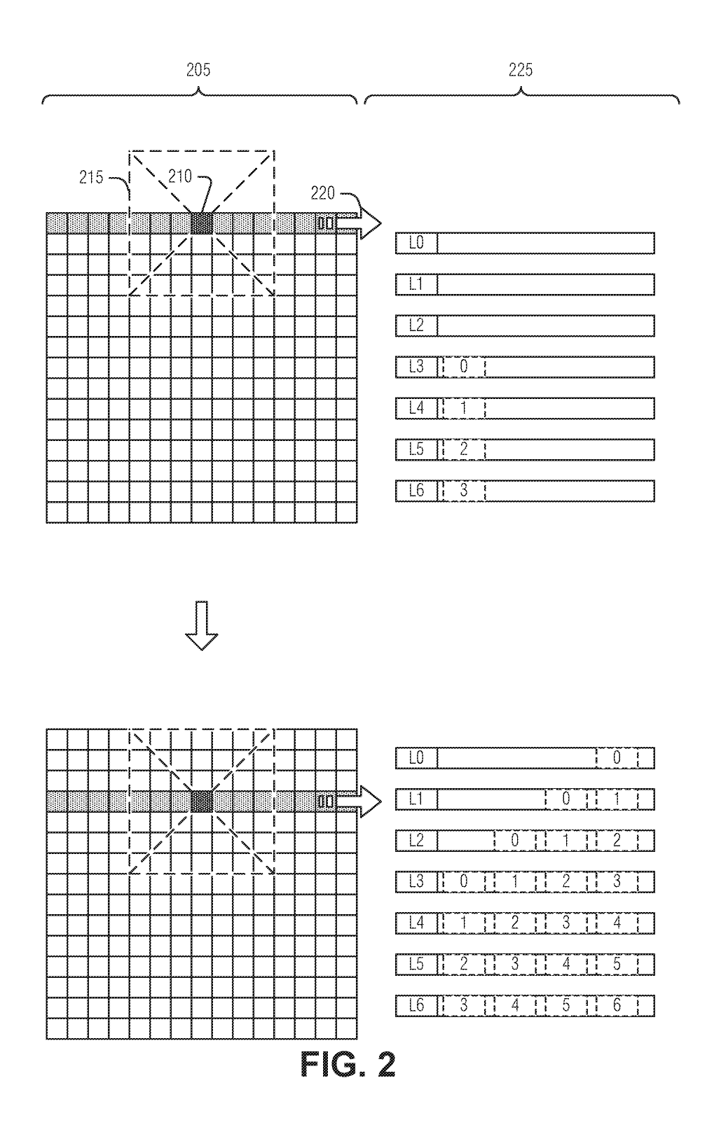

FIG. 2 illustrates an example of obtaining elements in a grid scan and populating a set of displacement first-in-first-out (FIFO) buffers, according to an embodiment. Here, the grid 205 is being scanned in a raster scan order (e.g., left to right in a row and top to bottom between rows). The dimensions vertical (e.g., Y) and horizontal (e.g., X) refer to this scan order, such that distance within a row is horizontal and distance between rows is vertical. In an example, these dimensions correspond to real-world horizontal and vertical when the grid 205 is so oriented.

The displacement FIFOs 225 are established based on the maximum element move rate. For example, assume a maximum velocity of Vmax=seven grid cells (e.g., with 20 cm per cell, 10 ms frame time, this equals to a maximum velocity of 504 km/h), then when sorting, N=2*Vmax+1 open displacement FIFOs 225 are maintained. In an example, the displacement FIFOs are implemented with a linked list data structure.

The scan is cell-wise, such that, for the input row 220, the cell 210 from a previous update provides the elements being sorted. The elements will be within the window 215 cells from the source cell 210 because of the Vmax assumption above. As the scan progresses, for each input row, the elements are sorted into a FIFO 225 according to the updated Y position of the element. The element is appended to the FIFO 225 that corresponds to the element's relative vertical displacement. The middle FIFO—e.g., the Vmax+1 list, or list L3 as illustrated—is the “static” list, which collects elements with an updated vertical displacement less than one grid cell.

The neighbors to the middle FIFO are the plus or minus one FIFOs, for elements that move by one grid cell in the Y direction. Thus, for each row, all lists collect elements with same vertical displacement. Note that as the scan continues through the rows, the FIFOs 225 do not change. Rather, the destination cell rows are appended to the same list based on their displacement. Thus, list L3 has elements that refer to rows 0, 1, 2, and 3 as the scan has moved down to row three in the bottom of the figure. In this way, the number of FIFOs 225 remains the same throughout the scan.

As noted above, as the scan continues along the grid 205, new elements are appended to the end of each FIFO 225. Thus, any elements that are used earlier in the sort are always in the front of a list, ready to be sorted in the X direction in the second phase. The elements may be stored in memory in a linked list block structure, where elements are stored in blocks into a buffer, and headers with pointer to these blocks may be stored in a separate buffer. In an example, headers from different FIFOs may be mixed together when writing into memory. In an example, the headers are sorted into different queues after fetching out from memory.

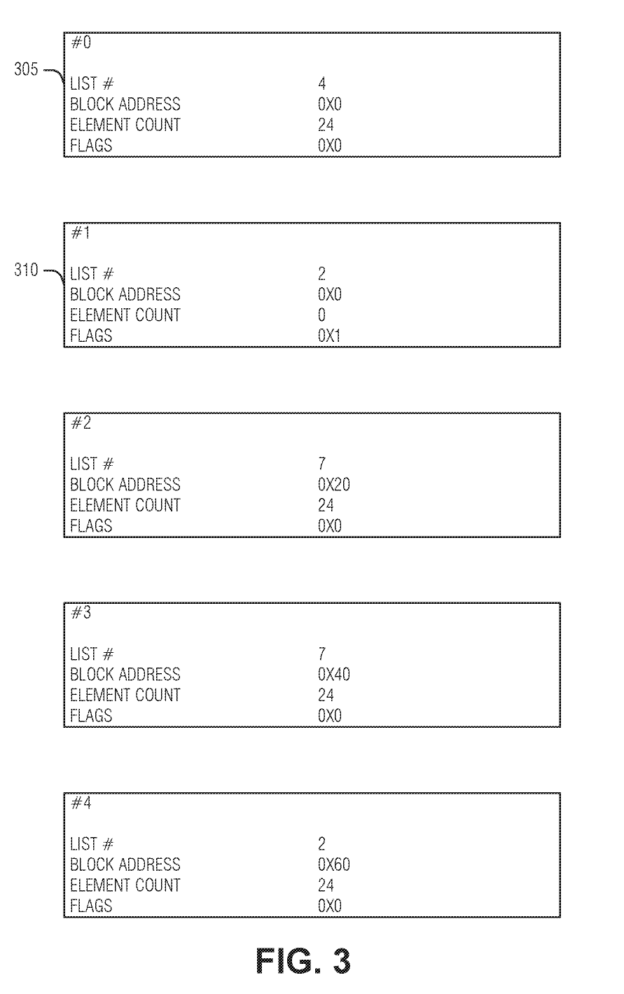

FIG. 3 illustrates examples of block headers for memory blocks containing displacement FIFO data, according to an embodiment. A block header includes an index, a field denoting from which FIFO its elements are from (e.g., LIST #), a memory address where the block may be found, a count of elements in the block, and flags. As illustrated, a standard block 305 includes a non-zero element count and also has a flag field indicating no special condition (e.g., 0x0).

The fence header 310 has a zero element count and a flag indicating a special condition (e.g., 0x1). For example, fence headers 310 may be generated rotating across all the FIFOs to mark the end of input rows. Thus, if there are zero or a small number (e.g., less than a full block's worth) of elements, the second phase sort may move forward without waiting for an end of grid header, for example.

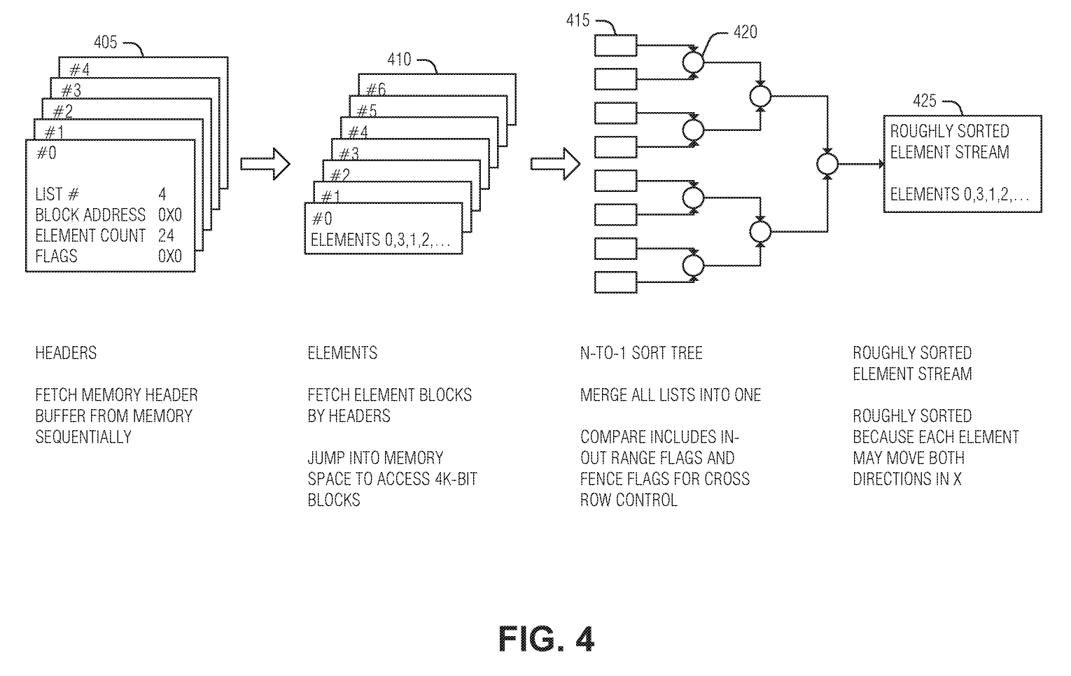

FIG. 4 illustrates an example of a component message flow for roughly sorting elements in displacement FIFO buffers stored in memory, according to an embodiment. The illustrated component message flow pre-processes elements being read from memory to sort in the horizontal direction. Headers 405 are pre-fetched and used to retrieve the elements in the FIFOs 410 from memory. These elements are provided, in order to the N-to-1 sort tree, where each input 415 corresponds to a FIFO 410.

The N-to-1 Tree merges all the roughly sorted FIFOs 410 into one. There is no assumption for each FIFO 410 where the first element is located (e.g., into what cell), other than it is not more than N cells behind any element in the same FIFO 410, thus, roughly sorted. To maintain this constraint, when merging, the comparators 420 compare two elements 415 and let the element 415 with the lowest cell index pass. Thus, the comparator 420 compares both the horizontal and the vertical values of the elements 415 to determine which is lower. At each comparator 420, the lowest elements 415 move one, eventually being added to the roughly sorted element stream 425. Again, the comparison implemented by the comparators 420 includes the vertical position, so cross-row sorting is accounted for without synchronization and its additional control logic. As noted above, flags may be used in the headers 405 to identify start of grid nodes (e.g., to be ignored), end of grid nodes (e.g., terminate the kernel), or fence nodes.

The result stream (e.g., roughly sorted elements stream 425) is a roughly sorted element stream where elements are never more than N (e.g., Vmax*2+1) cells away from where it will be when fully sorted. The roughly sorted element stream 425 may then be used as input into the fine sort described below, which fully sorts the elements into the updated cells.

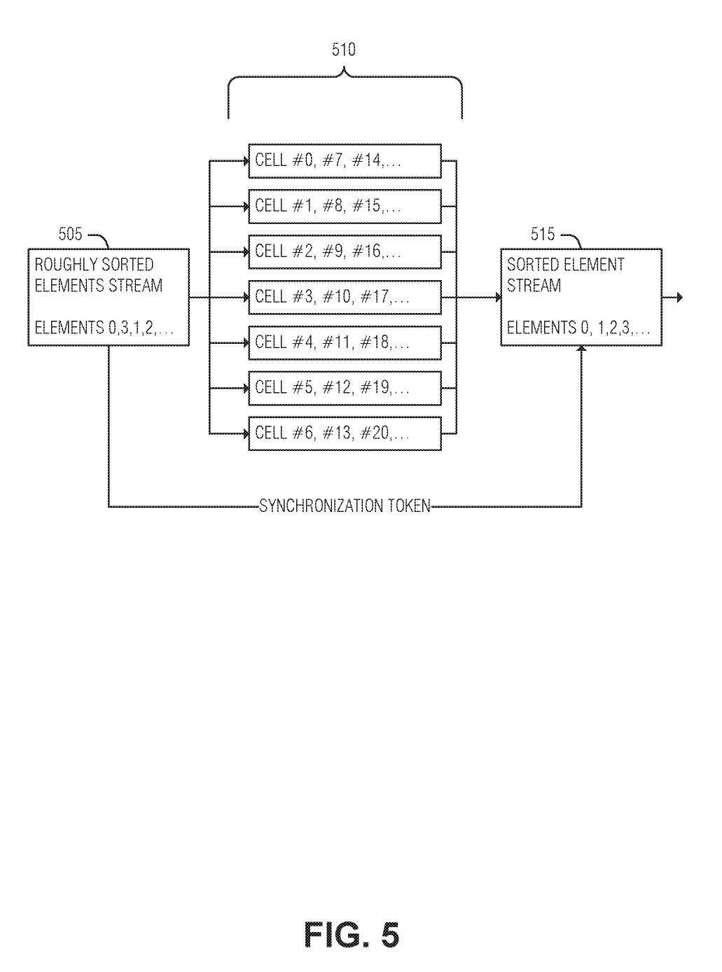

FIG. 5 illustrates an example of a component message flow for completing a sort from a roughly sorted elements stream 505, according to an embodiment. Here, there is one queue 510 per cell in the current range. Thus, if cell zero is the current cell, and the maximum element move rate is seven, then there is a queue for each of cells 0, 1, 2, 3, 4, 5, and 6 (only positive horizontal movement is possible at the beginning of a row). Similarly, if the current cell is 10, there is a queue for cells, 4, 5, 6, 7, 8, 9, 10, 11, 12, 13, 14, 15, and 16 (to account for the possible positive or negative horizontal displacement at the target cell). The queues are updated as they are flushed, such that the cell zero queue becomes the largest cell index when the cell zero values are flushed to the sorted element stream 515.

The window moves along with the input element. When any element is encountered that is outside the current window (e.g., it doesn't correspond to any cell represented by the queues 510), then there are some of the cells in the window that will not receive any more elements and are ready to be flushed to the sorted element stream 515 (e.g., and to a backend or other consumer of the sort). The cells ready to be flushed are the lower order cells. As they are flushed, the queues 510 are assigned the next cells in the window, efficiently rotating (e.g., rolling) through the cells without devoting additional resources (e.g., registers, memory, etc.) to the queues 510.

In an example, if the window moves by a large distance, potentially many cells should be marked as complete. Here, instead of rolling the queues 510 forward, additional processing circuitry may be used to handle this burst behavior in a single clock cycle to avoid backpressure in some cases. This lack of data may be signaled to the sorted element stream 515 by the illustrated synchronization token.

The elements in the output stream 515 are fully sorted into grid cell order. The sorted element stream 515 may begin outputting elements as soon as the first Vmax rows are obtained at the vertical sort phase. This reduces latency, making real-time sensor fusion based control systems more effective. Further, the efficient memory management enables a modest FPGA to provide the real-time sorting on real-world data sets.

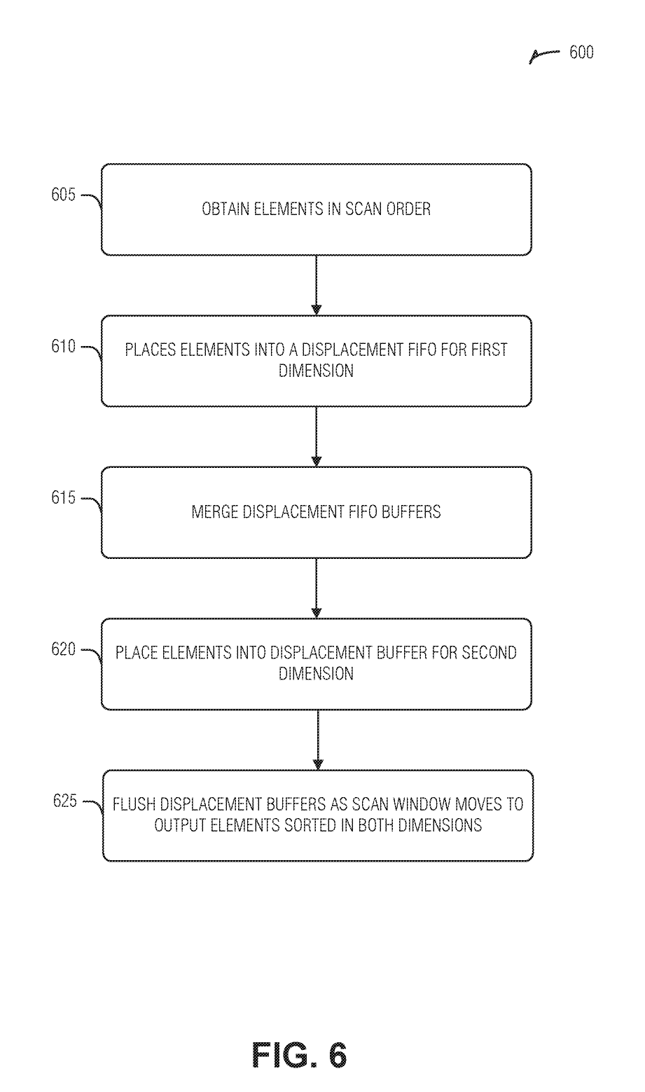

FIG. 6 illustrates a flow diagram of an example of a method 600 for a localized grid sort, according to an embodiment. The operations of the method 600 are implemented in processing hardware such as that described above and below (e.g., processing circuitry).

At operation 605, elements to sort are obtained (e.g., received or retrieved). Here, each element has a first-dimension value and a second-dimension value. The element also corresponds to a cell. In an example, the cell value corresponds to a cell of a multidimensional grid into which a respective element was placed prior to an update of the respective first-dimension value and the second-dimension value of the element. As explained above, the cell is the last place the element was, the first-dimension and second-dimension values are where the cell is after the update. In an example, the first dimension is horizontal and the second dimension is vertical. In an example, the elements are obtained from cells ordered by the second dimension.

At operation 610, each element in the elements is placed into (e.g., appended onto) one of a set of FIFO buffers based on a difference between the first-dimension value for the element and a first coordinate of the cell value in the first dimension. Thus, if the cell has a coordinate of X:1, Y:5, and the element dimensional values are X:6, Y:3, then the difference in the Y direction is −2.

In an example, the set of FIFO buffers are ordered around zero, with a highest value member of the set being a complement of the lowest value member of the set, the highest value corresponding to the maximum element move parameter. Thus, the element with the cell coordinate of X:1, Y:5, and the element dimensional values of X:6, Y:3 would be placed in the FIFO corresponding to a vertical displacement of −2. Similarly, if an element has a source cell of X:7, Y:890, and its multidimensional values are X:14, Y:888, then it would also be placed into the −2 vertical displacement FIFO. This arrangement enables a fixed number of FIFOs to be used to process the entire grid. In an example, the set of FIFO buffers are linked lists.

In an example, the maximum element move parameter is seven. In an example, a cell corresponds to a twenty centimeter square area in a physical space. In an example, elements are updated every ten milliseconds. As noted earlier, these parameters provide for physical element movement of up to 504 kilometers per hour while using only fifteen FIFOs.

In an example, placing the element into one of a set of FIFO buffers includes writing the element to a block. In an example, the block is placed into memory in response to reaching a predetermined size. Here, the elements are added to buffers (e.g., registers) until the predetermined size (e.g., four kilobytes) is reach. This block-based memory access reduces memory access latencies and improves overall sort performance in hardware.

In an example, a block header is placed in memory separately from the block. This enables an efficient memory access to store block headers together to retrieve several headers for each memory operation. In an example, the block header includes at least one of an identifier of a FIFO buffer in the list of FIFO buffers, an address of the block, a number of elements in the block, or a flag. In an example, the flag corresponds to at least one of a row begin, a row end, a column begin, a column end, a grid begin, a grid end, or no-special-condition

At operation 615, the set of FIFO buffers is merged by comparing every next element from the set of FIFO buffers on both the first-dimension value and the second-dimension value to output a lowest value element at each comparison to create a stream of elements sorted in the first dimension. In an example, merging the set of FIFO buffers includes reading blocks from memory to populate each input of a comparing structure. In an example, the comparing structure includes a number of inputs equal to a number of FIFO buffers in the set of FIFO buffers, a single output, and a set of layers between the input and the output. Here, each layer has comparators to compare two elements and output one of the two compared elements. The number of comparators in any layer being half that of a previous layer or the inputs. Such a structure is illustrated above with respect to FIG. 4.

At operation 620, elements from the element stream are placed into a set of window buffers equal to two times a maximum move parameter plus one, centered on zero. In an example, each buffer in the window buffers represent a single cell in the grid.

At operation 625, flushing a lowest buffer (e.g., lowest cell) from the set of buffers, and moving the set of window buffers, in response to the next element in the element stream not being in the set of window buffers to produce an output stream of sorted elements. In an example, moving the set of window buffers includes assigning a highest value cell to the flushed buffer.

The method 600 may be extended to processing grids in greater than two dimensions by repeating the operations 605-625 for each additional dimension after the first two dimensions are sorted. Thus, the method 600 may include the operation of repeating the localized grid sort on the output stream of sorted elements on a third dimension, or greater dimensions.

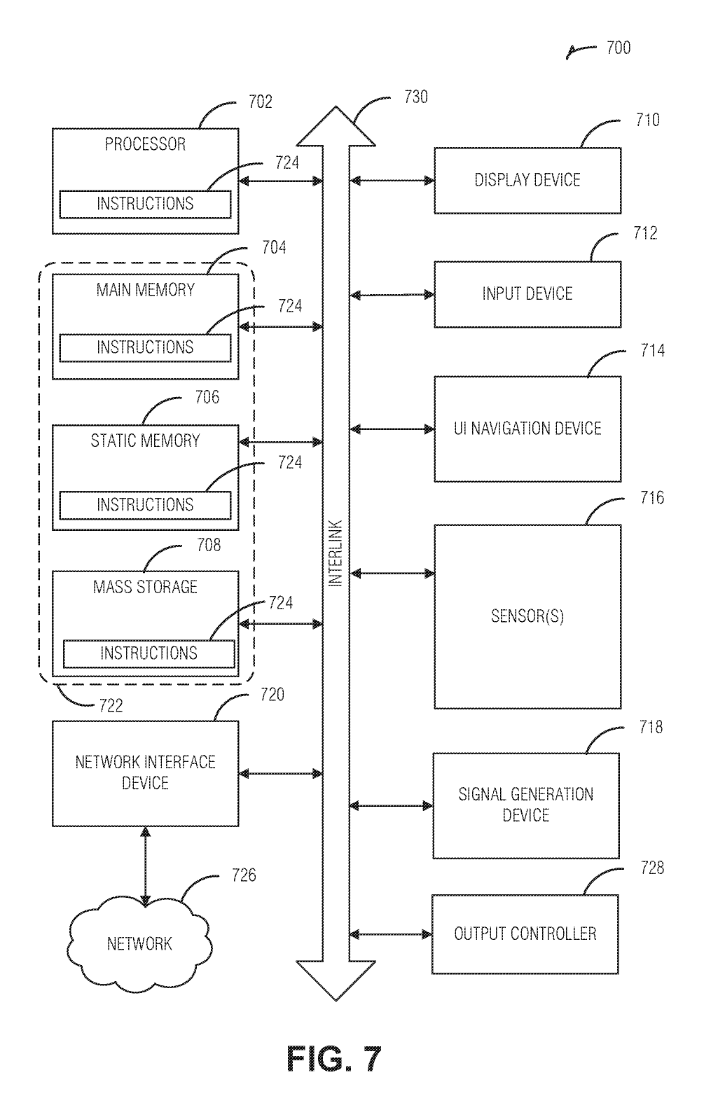

FIG. 7 illustrates a block diagram of an example machine 700 upon which any one or more of the techniques (e.g., methodologies) discussed herein may perform. Examples, as described herein, may include, or may operate by, logic or a number of components, or mechanisms in the machine 700. Circuitry (e.g., processing circuitry) is a collection of circuits implemented in tangible entities of the machine 700 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 700 follow.

In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 700 may include a hardware processor 702 (e.g., a central processing unit (CPU), a graphics processing unit (GPU), a hardware processor core, or any combination thereof), a main memory 704, a static memory (e.g., memory or storage for firmware, microcode, a basic-input-output (BIOS), unified extensible firmware interface (UEFI), etc.) 706, and mass storage 708 (e.g., hard drive, tape drive, flash storage, or other block devices) some or all of which may communicate with each other via an interlink (e.g., bus) 730. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 708, a signal generation device 718 (e.g., a speaker), a network interface device 720, and one or more sensors 716, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 702, the main memory 704, the static memory 706, or the mass storage 708 may be, or include, a machine readable medium 722 on which is stored one or more sets of data structures or instructions 724 (e.g., software) embodying or utilized by any one or more of the techniques or functions described herein. The instructions 724 may also reside, completely or at least partially, within any of registers of the processor 702, the main memory 704, the static memory 706, or the mass storage 708 during execution thereof by the machine 700. In an example, one or any combination of the hardware processor 702, the main memory 704, the static memory 706, or the mass storage 708 may constitute the machine readable media 722. While the machine readable medium 722 is illustrated as a single medium, the term “machine readable medium” may include a single medium or multiple media (e.g., a centralized or distributed database, and/or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine readable medium examples may include solid-state memories, optical media, magnetic media, and signals (e.g., radio frequency signals, other photon based signals, sound signals, etc.). In an example, a non-transitory machine readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine readable medium.

### Additional Notes & Examples

Example 1 is a device to implemented a localized grid sort, the device comprising: an input interface to obtain elements to sort, each element of the elements having a first-dimension value and a second-dimension value, and corresponds to a cell value; a memory writer to place, for each element in the elements, the element into one of a set of first-in-first-out (FIFO) buffers based on a difference between the first-dimension value for the element and a first coordinate of the cell value in the first-dimension; comparators to merge the set of FIFO buffers by comparing every next element from the set of FIFO buffers on both the first-dimension value and the second-dimension value to output a lowest value element at each comparison to create an element stream sorted in the first-dimension; moving window circuitry to: place elements from the element stream into a set of window buffers equal to two times a maximum element move parameter plus one, centered on zero; and flush a lowest buffer from the set of buffers into an output interface, and move the set of window buffers, in response to the next element in the element stream not being in the set of window buffers to produce an output stream of sorted elements.

In Example 2, the subject matter of Example 1 includes, wherein the set of FIFO buffers are ordered around zero, with a highest value member of the set being a complement of the lowest value member of the set, the highest value corresponding to the maximum element move parameter.

In Example 3, the subject matter of Examples 1-2 includes, wherein the cell value corresponds to a cell of a multidimensional grid into which a respective element was placed prior to an update of the respective first-dimension value and the second-dimension value of the element.

In Example 4, the subject matter of Examples 1-3 includes, wherein, to move the set of window buffers, the moving window circuitry assigns a highest value to the flushed buffer.

In Example 5, the subject matter of Examples 1-4 includes, wherein the first-dimension is horizontal and the second-dimension is vertical.

In Example 6, the subject matter of Examples 1-5 includes, control circuitry to repeat the localized grid sort on the output stream of sorted elements on a third dimension.

In Example 7, the subject matter of Examples 1-6 includes, wherein, to place the element into one of the set of FIFO buffers, the memory writer writes the element to a block.

In Example 8, the subject matter of Example 7 includes, wherein the block is placed into memory in response to reaching a predetermined size.

In Example 9, the subject matter of Example 8 includes, wherein a block header corresponding to the block is placed into memory separate from the block.

In Example 10, the subject matter of Example 9 includes, wherein the block header includes at least one of: an identifier of a FIFO buffer in the list of FIFO buffers, an address of the block, a number of elements in the block, or a flag.

In Example 11, the subject matter of Example 10 includes, wherein the flag corresponds to at least one of: a row end, a column end, a grid end, or no-special-condition.

In Example 12, the subject matter of Examples 9-11 includes, wherein block headers are stored contiguously in memory.

In Example 13, the subject matter of Examples 8-12 includes, wherein, to merge the set of FIFO buffers, the comparators are provided blocks read from memory to populate each input of a comparing structure.

In Example 14, the subject matter of Example 13 includes, wherein the comparing structure includes a number of inputs equal to a cardinality of the set of FIFO buffers; a single output; and a set of layers between the input and the output, each layer having comparators to compare two elements and output one of the two compared elements, a number of comparators in any layer being half that of a previous layer or the inputs.

In Example 15, the subject matter of Examples 1-14 includes, wherein elements are obtained from cells ordered by the second-dimension.

In Example 16, the subject matter of Examples 1-15 includes, wherein the FIFO buffers in the set of FIFO buffers are linked lists.

In Example 17, the subject matter of Examples 1-16 includes, wherein the maximum element move parameter is seven.

In Example 18, the subject matter of Example 17 includes, wherein a cell corresponds to a twenty centimeter square area in a physical space.

In Example 19, the subject matter of Examples 17-18 includes, wherein elements are updated every ten milliseconds.

Example 20 is a method for localized grid sort, the method comprising: obtaining elements to sort, each element of the elements having a first-dimension value and a second-dimension value, and corresponds to a cell value; placing, for each element in the elements, the element into one of a set of first-in-first-out (FIFO) buffers based on a difference between the first-dimension value for the element and a first coordinate of the cell value in the first-dimension; merging the set of FIFO buffers by comparing every next element from the set of FIFO buffers on both the first-dimension value and the second-dimension value to output a lowest value element at each comparison to create an element stream sorted in the first-dimension; placing elements from the element stream into a set of window buffers equal to two times a maximum element move parameter plus one, centered on zero; and flushing a lowest buffer from the set of buffers, and moving the set of window buffers, in response to the next element in the element stream not being in the set of window buffers to produce an output stream of sorted elements.

In Example 21, the subject matter of Example 20 includes, wherein the set of FIFO buffers are ordered around zero, with a highest value member of the set being a complement of the lowest value member of the set, the highest value corresponding to the maximum element move parameter.

In Example 22, the subject matter of Examples 20-21 includes, wherein the cell value corresponds to a cell of a multidimensional grid into which a respective element was placed prior to an update of the respective first-dimension value and the second-dimension value of the element.

In Example 23, the subject matter of Examples 20-22 includes, wherein moving the set of window buffers includes assigning a highest value to the flushed buffer.

In Example 24, the subject matter of Examples 20-23 includes, wherein the first-dimension is horizontal and the second-dimension is vertical.

In Example 25, the subject matter of Examples 20-24 includes, repeating the localized grid sort on the output stream of sorted elements on a third dimension.

In Example 26, the subject matter of Examples 20-25 includes, wherein placing the element into one of the set of FIFO buffers includes writing the element to a block.

In Example 27, the subject matter of Example 26 includes, wherein the block is placed into memory in response to reaching a predetermined size.

In Example 28, the subject matter of Example 27 includes, wherein a block header corresponding to the block is placed into memory separate from the block.

In Example 29, the subject matter of Example 28 includes, wherein the block header includes at least one of: an identifier of a FIFO buffer in the list of FIFO buffers, an address of the block, a number of elements in the block, or a flag.

In Example 30, the subject matter of Example 29 includes, wherein the flag corresponds to at least one of: a row end, a column end, a grid end, or no-special-condition.

In Example 31, the subject matter of Examples 28-30 includes, wherein block headers are stored contiguously in memory.

In Example 32, the subject matter of Examples 27-31 includes, wherein merging the set of FIFO buffers includes reading blocks from memory to populate each input of a comparing structure.

In Example 33, the subject matter of Example 32 includes, wherein the comparing structure includes a number of inputs equal to a cardinality of the set of FIFO buffers; a single output; and a set of layers between the input and the output, each layer having comparators to compare two elements and output one of the two compared elements, a number of comparators in any layer being half that of a previous layer or the inputs.

In Example 34, the subject matter of Examples 20-33 includes, wherein elements are obtained from cells ordered by the second-dimension.

In Example 35, the subject matter of Examples 20-34 includes, wherein the FIFO buffers in the set of FIFO buffers are linked lists.

In Example 36, the subject matter of Examples 20-35 includes, wherein the maximum element move parameter is seven.

In Example 37, the subject matter of Example 36 includes, wherein a cell corresponds to a twenty centimeter square area in a physical space.

In Example 38, the subject matter of Examples 36-37 includes, wherein elements are updated every ten milliseconds.

Example 39 is at least one machine readable medium including instructions for localized grid sort, the instructions, when executed by processing circuitry, cause the processing circuitry to perform operations comprising: obtaining elements to sort, each element of the elements having a first-dimension value and a second-dimension value, and corresponds to a cell value; placing, for each element in the elements, the element into one of a set of first-in-first-out (FIFO) buffers based on a difference between the first-dimension value for the element and a first coordinate of the cell value in the first-dimension; merging the set of FIFO buffers by comparing every next element from the set of FIFO buffers on both the first-dimension value and the second-dimension value to output a lowest value element at each comparison to create an element stream sorted in the first-dimension; placing elements from the element stream into a set of window buffers equal to two times a maximum element move parameter plus one, centered on zero; and flushing a lowest buffer from the set of buffers, and moving the set of window buffers, in response to the next element in the element stream not being in the set of window buffers to produce an output stream of sorted elements.

In Example 40, the subject matter of Example 39 includes, wherein the set of FIFO buffers are ordered around zero, with a highest value member of the set being a complement of the lowest value member of the set, the highest value corresponding to the maximum element move parameter.

In Example 41, the subject matter of Examples 39-40 includes, wherein the cell value corresponds to a cell of a multidimensional grid into which a respective element was placed prior to an update of the respective first-dimension value and the second-dimension value of the element.

In Example 42, the subject matter of Examples 39-41 includes, wherein moving the set of window buffers includes assigning a highest value to the flushed buffer.

In Example 43, the subject matter of Examples 39-42 includes, wherein the first-dimension is horizontal and the second-dimension is vertical.

In Example 44, the subject matter of Examples 39-43 includes, wherein the operations comprise repeating the localized grid sort on the output stream of sorted elements on a third dimension.

In Example 45, the subject matter of Examples 39-44 includes, wherein placing the element into one of the set of FIFO buffers includes writing the element to a block.

In Example 46, the subject matter of Example 45 includes, wherein the block is placed into memory in response to reaching a predetermined size.

In Example 47, the subject matter of Example 46 includes, wherein a block header corresponding to the block is placed into memory separate from the block.

In Example 48, the subject matter of Example 47 includes, wherein the block header includes at least one of: an identifier of a FIFO buffer in the list of FIFO buffers, an address of the block, a number of elements in the block, or a flag.

In Example 49, the subject matter of Example 48 includes, wherein the flag corresponds to at least one of: a row end, a column end, a grid end, or no-special-condition.

In Example 50, the subject matter of Examples 47-49 includes, wherein block headers are stored contiguously in memory.

In Example 51, the subject matter of Examples 46-50 includes, wherein merging the set of FIFO buffers includes reading blocks from memory to populate each input of a comparing structure.

In Example 52, the subject matter of Example 51 includes, wherein the comparing structure includes a number of inputs equal to a cardinality of the set of FIFO buffers; a single output; and a set of layers between the input and the output, each layer having comparators to compare two elements and output one of the two compared elements, a number of comparators in any layer being half that of a previous layer or the inputs.

In Example 53, the subject matter of Examples 39-52 includes, wherein elements are obtained from cells ordered by the second-dimension.

In Example 54, the subject matter of Examples 39-53 includes, wherein the FIFO buffers in the set of FIFO buffers are linked lists.

In Example 55, the subject matter of Examples 39-54 includes, wherein the maximum element move parameter is seven.

In Example 56, the subject matter of Example 55 includes, wherein a cell corresponds to a twenty centimeter square area in a physical space.

In Example 57, the subject matter of Examples 55-56 includes, wherein elements are updated every ten milliseconds.

Example 58 is a system for localized grid sort, the system comprising: means for obtaining elements to sort, each element of the elements having a first-dimension value, and a second-dimension value, and corresponding to a cell value; means for placing, for each element in the elements, the element into one of a set of first-in-first-out (FIFO) buffers based on a difference between the first-dimension value for the element and a first coordinate of the cell value in the first-dimension; means for merging the set of FIFO buffers by comparing every next element from the set of FIFO buffers on both the first-dimension value and the second-dimension value to output a lowest value element at each comparison to create an element stream sorted in the first-dimension; means for placing elements from the element stream into a set of window buffers equal to two times a maximum element move parameter plus one, centered on zero; and means for flushing a lowest buffer from the set of buffers, and moving the set of window buffers, in response to the next element in the element stream not being in the set of window buffers to produce an output stream of sorted elements.

In Example 59, the subject matter of Example 58 includes, wherein the set of FIFO buffers are ordered around zero, with a highest value member of the set being a complement of the lowest value member of the set, the highest value corresponding to the maximum element move parameter.

In Example 60, the subject matter of Examples 58-59 includes, wherein the cell value corresponds to a cell of a multidimensional grid into which a respective element was placed prior to an update of the respective first-dimension value and the second-dimension value of the element.

In Example 61, the subject matter of Examples 58-60 includes, wherein the means for moving the set of window buffers include means for assigning a highest value to the flushed buffer.

In Example 62, the subject matter of Examples 58-61 includes, wherein the first-dimension is horizontal and the second-dimension is vertical.

In Example 63, the subject matter of Examples 58-62 includes, means for repeating the localized grid sort on the output stream of sorted elements on a third dimension.

In Example 64, the subject matter of Examples 58-63 includes, wherein the means for placing the element into one of the set of FIFO buffers include means for writing the element to a block.

In Example 65, the subject matter of Example 64 includes, wherein the block is placed into memory in response to reaching a predetermined size.

In Example 66, the subject matter of Example 65 includes, wherein a block header corresponding to the block is placed into memory separate from the block.

In Example 67, the subject matter of Example 66 includes, wherein the block header includes at least one of: an identifier of a FIFO buffer in the list of FIFO buffers, an address of the block, a number of elements in the block, or a flag.

In Example 68, the subject matter of Example 67 includes, wherein the flag corresponds to at least one of: a row end, a column end, a grid end, or no-special-condition.

In Example 69, the subject matter of Examples 66-68 includes, wherein block headers are stored contiguously in memory.

In Example 70, the subject matter of Examples 65-69 includes, wherein the means for merging the set of FIFO buffers include means for reading blocks from memory to populate each input of a comparing structure.

In Example 71, the subject matter of Example 70 includes, wherein the comparing structure includes a number of inputs equal to a cardinality of the set of FIFO buffers; a single output; and a set of layers between the input and the output, each layer having comparators to compare two elements and output one of the two compared elements, a number of comparators in any layer being half that of a previous layer or the inputs.

In Example 72, the subject matter of Examples 58-71 includes, wherein elements are obtained from cells ordered by the second-dimension.

In Example 73, the subject matter of Examples 58-72 includes, wherein the FIFO buffers in the set of FIFO buffers are linked lists.

In Example 74, the subject matter of Examples 58-73 includes, wherein the maximum element move parameter is seven.

In Example 75, the subject matter of Example 74 includes, wherein a cell corresponds to a twenty centimeter square area in a physical space.

In Example 76, the subject matter of Examples 74-75 includes, wherein elements are updated every ten milliseconds.

Example 77 is at least one machine-readable medium including instructions that, when executed by processing circuitry, cause the processing circuitry to perform operations to implement of any of Examples 1-76.

Example 78 is an apparatus comprising means to implement of any of Examples 1-76.

Example 79 is a system to implement of any of Examples 1-76.

Example 80 is a method to implement of any of Examples 1-76.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B”, unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A device to implement a localized grid sort, the device comprising:
an input interface to obtain elements to sort, each element of the elements having a first-dimension value and a second-dimension value, and corresponds to a cell value;
a memory writer to place, for each element in the elements, the element into one of a set of first-in-first-out (FIFO) buffers based on a difference between the first-dimension value for the element and a first coordinate of the cell value in the first-dimension;
comparators to merge the set of FIFO buffers by comparing every next element from the set of FIFO buffers on both the first-dimension value and the second-dimension value to output a lowest value element at each comparison to create an element stream sorted in the first-dimension; and
moving window circuitry to:
place elements from the element stream into a set of window buffers equal to two times a maximum element move parameter plus one, centered on zero; and
flush a lowest buffer from the set of buffers into an output interface, and move the set of window buffers, in response to the next element in the element stream not being in the set of window buffers to produce an output stream of sorted elements.

2. The device of claim 1, wherein the set of FIFO buffers are ordered around zero, with a highest value member of the set being a complement of the lowest value member of the set, the highest value corresponding to the maximum element move parameter.

3. The device of claim 1, wherein, to move the set of window buffers, the moving window circuitry assigns a highest value to the flushed buffer.

4. The device of claim 1, wherein, to place the element into one of the set of FIFO buffers, the memory writer writes the element to a block.

5. The device of claim 4, wherein the block is placed into memory in response to reaching a predetermined size.

6. The device of claim 5, wherein, to merge the set of FIFO buffers, the comparators are provided blocks read from memory to populate each input of a comparing structure.

7. The device of claim 6, wherein the comparing structure includes a number of inputs equal to a cardinality of the set of FIFO buffers;
a single output; and
a set of layers between the input and the output, each layer having comparators to compare two elements and output one of the two compared elements, a number of comparators in any layer being half that of a previous layer or the inputs.

8. The device of claim 1, wherein elements are obtained from cells ordered by the second-dimension.

9. A method for localized grid sort, the method comprising:
obtaining elements to sort, each element of the elements having a first-dimension value and a second-dimension value, and corresponds to a cell value;
placing, for each element in the elements, the element into one of a set of first-in-first-out (FIFO) buffers based on a difference between the first-dimension value for the element and a first coordinate of the cell value in the first-dimension;
merging the set of FIFO buffers by comparing every next element from the set of FIFO buffers on both the first-dimension value and the second-dimension value to output a lowest value element at each comparison to create an element stream sorted in the first-dimension;
placing elements from the element stream into a set of window buffers equal to two times a maximum element move parameter plus one, centered on zero; and
flushing a lowest buffer from the set of buffers, and moving the set of window buffers, in response to the next element in the element stream not being in the set of window buffers to produce an output stream of sorted elements.

10. The method of claim 9, wherein the set of FIFO buffers are ordered around zero, with a highest value member of the set being a complement of the lowest value member of the set, the highest value corresponding to the maximum element move parameter.

11. The method of claim 9, wherein moving the set of window buffers includes assigning a highest value to the flushed buffer.

12. The method of claim 9, wherein placing the element into one of the set of FIFO buffers includes writing the element to a block.

13. The method of claim 12, wherein the block is placed into memory in response to reaching a predetermined size.

14. The method of claim 13, wherein merging the set of FIFO buffers includes reading blocks from memory to populate each input of a comparing structure.

15. The method of claim 14, wherein the comparing structure includes a number of inputs equal to a cardinality of the set of FIFO buffers;
a single output; and
a set of layers between the input and the output, each layer having comparators to compare two elements and output one of the two compared elements, a number of comparators in any layer being half that of a previous layer or the inputs.

16. The method of claim 9, wherein elements are obtained from cells ordered by the second-dimension.

17. At least one non-transitory machine readable medium including instructions for localized grid sort, the instructions, when executed by processing circuitry, cause the processing circuitry to perform operations comprising:
obtaining elements to sort, each element of the elements having a first-dimension value and a second-dimension value, and corresponds to a cell value;
placing, for each element in the elements, the element into one of a set of first-in-first-out (FIFO) buffers based on a difference between the first-dimension value for the element and a first coordinate of the cell value in the first-dimension;
merging the set of FIFO buffers by comparing every next element from the set of FIFO buffers on both the first-dimension value and the second-dimension value to output a lowest value element at each comparison to create an element stream sorted in the first-dimension;
placing elements from the element stream into a set of window buffers equal to two times a maximum element move parameter plus one, centered on zero; and
flushing a lowest buffer from the set of buffers, and moving the set of window buffers, in response to the next element in the element stream not being in the set of window buffers to produce an output stream of sorted elements.

18. The at least one machine readable medium of claim 17, wherein the set of FIFO buffers are ordered around zero, with a highest value member of the set being a complement of the lowest value member of the set, the highest value corresponding to the maximum element move parameter.

19. The at least one machine readable medium of claim 17, wherein moving the set of window buffers includes assigning a highest value to the flushed buffer.

20. The at least one machine readable medium of claim 17, wherein placing the element into one of the set of FIFO buffers includes writing the element to a block.

21. The at least one machine readable medium of claim 20, wherein the block is placed into memory in response to reaching a predetermined size.

22. The at least one machine readable medium of claim 21, wherein merging the set of FIFO buffers includes reading blocks from memory to populate each input of a comparing structure.

23. The at least one machine readable medium of claim 22, wherein the comparing structure includes a number of inputs equal to a cardinality of the set of FIFO buffers;
a single output; and
a set of layers between the input and the output, each layer having comparators to compare two elements and output one of the two compared elements, a number of comparators in any layer being half that of a previous layer or the inputs.

24. The at least one machine readable medium of claim 17, wherein elements are obtained from cells ordered by the second-dimension.
